(19) United States
(12) Patent Application Publication
(10) Pub. No.: US 2002/0032777 A1
(43) Pub. Date: Mar. 14, 2002

(54) Load sharing apparatus and a load estimation method

(76) Inventors: Yoko Kawata, Kawasaki (JP); Tadashi Takeuchi, Yokohama (JP); Damien Le Moal, Sagamihara (JP)

Correspondence Address: Mattingly, Stanger & Malur, P.C., 104 East Hume Avenue, Alexandrira, VA, 22301, US

(21) Appl. No.: 09/828,140

(22) Filed: Apr. 9, 2001

(30) Foreign Application Priority Data
Sep. 11, 2000 (JP) 2000-280118

(51) Int. Cl. G06F 15/16; G06F 15/173

(52) U.S. Cl. 709/226; 709/203; 709/219

(57) ABSTRACT

The present invention provides load balancing based on the real-time load status of servers. A load balancer providing load balancing in multiple servers for service requests from a client includes: means for estimating load resulting from the service requests based on header information in the service request packets; and means for managing estimation values for each server to which requests are to be sent.

### BACKGROUND OF THE INVENTION

The present invention relates to a technology for balancing server load the distributes requests from a client to a plurality of servers.

Recent years have seen the rapid proliferation of the Internet and intranets, and the load placed on servers has been increasing as well. For this reason, there is a need for a technology in which service requests from a client are distributed to multiple servers capable of providing identical services.

For example, a method has been proposed in which server loads are monitored periodically and the servers to which service requests are to be distributed are dynamically determined based on server loads. In Japanese laid-open patent publication number Hei 11-250020, each server periodically measures the number of IP packets per unit time and informs a state management server of its own load status. The client looks at the load status for each server in the state management server and sends its service request to the server with the lowest load. Another example is presented in “NetDispatcher: A TCP Connection Router” (G. Goldszmidt and G. Hunt, Technical Report IBM Research. RC20853, May, 1997). In this method, a load balancer is interposed between multiple clients and multiple servers. The load balancer and each of the servers periodically measure load evaluation values for the servers, and servers to which requests are to be sent are determined dynamically from these load estimation values.

In conventional methods where servers periodically send their own load information to a state management server or a load balancer, as described above, real-time server load cannot be detected if load monitoring takes place at long intervals. Since accesses to servers generally come in a concentrated manner, the lack of real-time knowledge of server load status can result in overloading of the servers when there is a spike in accesses. If, on the other hand, load monitoring is performed at short intervals, the CPU load on the servers and the load balancer and the communication load between the servers and the load balancer can reduce the overall performance of the server system.

### SUMMARY OF THE INVENTION

The object of the present invention is to provide a load balancer and a load balancing method that provides appropriate load balancing even if there is a spike in accesses to servers and that can maintain high overall performance for a server system.

The present invention provides a load balancing device and a load estimation method that allows real-time detection of server load status and that provides dynamic load distribution based on load status of individual servers without increasing the communication load between the servers and the load balancer or the CPU load on the servers. More specifically, the following means are provided.

1) A load balancer providing: means for analyzing a packet header in a service request packet from a client; means for estimating a load evaluation value indicating processing load on a server based on request contents of the service request packet; means for storing load status values for each server in the form of totals of load evaluations values of distributed service request packets over a fixed past period; and means for determining a server to which to send the service request based on the load status values.

2) A load balancer providing: means for identifying, from a packet header of a service request packet from a client, at least one of the following: a requested service type, a requested content data size, and an execution program for generating requested content data; means for estimating a load evaluation value indicating server processing load based on this information.

3) In order to implement the load estimation from item 2) above, the following means are provided for operations performed before the server system is activated or by a reserve system: means for requesting access to all services and all content data that can be provided by the servers; means for measuring response time for these requests; means for measuring server CPU load resulting from execution of operations associated with these requests; means for generating data used to determine a load evaluation value indicating load on said servers resulting from the service request data based on response time, CPU load, and response data size.

In the load balancer according to the present invention, the server processing load resulting from a service request is estimated each time a service request packet is received, and a load status value for each server is updated. Thus, load status of individual servers can be detected in real time. Also, since the dynamic load balancing of the present invention does not require communication between the servers and the load balancer and does not require execution of load status monitoring operations in the servers, there is no increase in server CPU load or in communication load between the servers and the load balancer.

### BRIEF DESCRIPTION OF THE DRAWINGS

FIG. 1 is an example of an embodiment of the primary functions of the load balancer and WWW system according to the present invention.

FIG. 2 is an example of an HTTP header from a service request packet from a client received by the load balancer.

FIG. 3 shows a method load evaluation table (one of the load estimation tables in an embodiment of the present invention).

FIG. 4 shows a content data table (one of the load estimation tables in an embodiment of the present invention).

FIG. 5 shows a data size load evaluation table (one of the load estimation tables in an embodiment of the present invention).

FIG. 6 shows a dynamic content generation program load evaluation table (one of the load estimation tables in an embodiment of the present invention).

FIG. 7 shows a weight table (one of the load estimation tables in an embodiment of the present invention).

FIG. 8 shows a server load management table.

FIG. 9 is a flowchart of a server load estimation operation in a load balancer.

FIG. 10 is a flowchart of a server selection operation in a load balancer.

FIG. 11 is a system architecture of a load estimation table generation/updating operation according to an embodiment of the present invention.

FIG. 12A is a flowchart of operations performed by a test machine in a load estimation table generation/updating operation according to an embodiment of the present invention.

FIG. 12B is a detailed flowchart of the access operation from FIG. 12A.

FIG. 13 is a flowchart of operations performed by a server in a load estimation table generation/updating operation according to an embodiment of the present invention.

FIG. 14 shows a response time table (method table) used in a load estimation table generation/updating operation according to an embodiment of the present invention.

FIG. 15 shows a response time table (content data table) used in a load estimation table generation/updating operation according to an embodiment of the present invention.

FIG. 16 shows a response time table (dynamic content generation program table) used in a load estimation table generation/updating operation according to an embodiment of the present invention.

FIG. 17 shows a CPU load table (method table) used in a load estimation table generation/updating operation according to an embodiment of the present invention.

FIG. 18 shows a CPU load table (dynamic content generation program table) used in a load estimation table generation/updating operation according to an embodiment of the present invention.

FIG. 19 is a CPU load table (content data table) used in a load estimation table generation/updating operation according to an embodiment of the present invention.

FIG. 20 is a flowchart of a load evaluation value generation operation in a load balancer according to an embodiment of the present invention.

FIG. 21 is a flowchart of a method load evaluation table generation/updating operation (one of the operations in the load evaluation value generation operation).

FIG. 22 is a flowchart of a content data table generation/updating operation (one of the operations in the load evaluation value generation operation).

FIG. 23 is a flowchart of a data size load evaluation table generation/updating operation (one of the operations in the load evaluation value generation operation).

FIG. 24 is a flowchart of a dynamic content generation program load evaluation table generation/updating operation (one of the operations in the load evaluation value generation operation).

### DESCRIPTION OF THE PREFERRED EMBODIMENT

The following is a detailed description of the embodiments of the present invention.

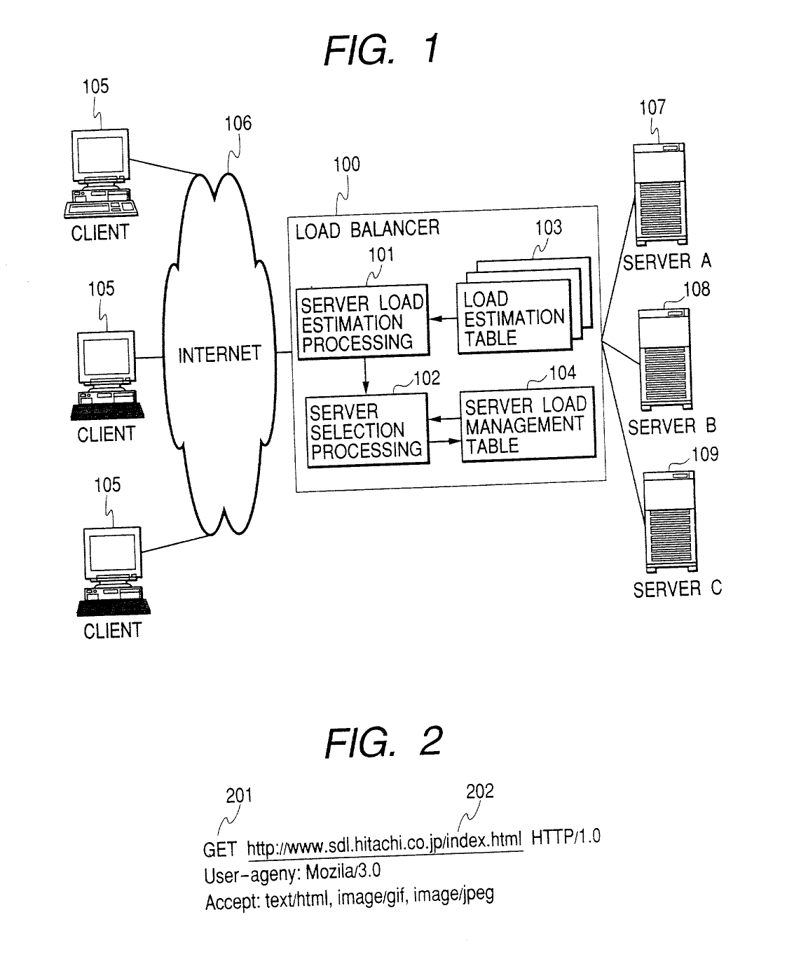

FIG. 1 shows a WWW (World Wide Web) system and the internal architecture of a load sharing device according to the present invention. In the WWW system shown in FIG. 1, multiple clients 105 send service requests to send service requests to servers. The service requests sent from the clients 105 go through a load balancer 100, which distributes the service requests from the clients 105 to the servers. Each server can provide identical services and content data. The processing power of the servers may be identical or different. In this embodiment, the load balancer 100 distributes service request packets to a server A 107, a server B 108, and a server C 109. The server A 107, the server B 108, and the server C 109 have different processing powers.

The load balancer 100 is formed primarily from a server load estimation processing module 101 and a server selection processing module 102. When a service request packet from a client 105 is received, the load balancer 100 obtains the contents of the service request from the packet.

Based on the contents of the service request, the server load estimation processing module 101 determines a load evaluation value indicating the processing load that the service request packet will place on a server. The module 101 determines load evaluation values by looking up a load estimation table 103.

Next, the server selection processing module 102 selects a server 105 to which the service request packet is to be transferred. This module 102 looks up a server load management table 104 to select the server with the lightest load. Then, the server load management table 104 is updated using the load evaluation value obtained from the server load estimation processing module 101. The destination address in the packet header of the service request packet is converted to the address of the server 107 selected by the server selection processing module 102, and the packet is sent to the server.

As described above, the server load management table 104 used to select the server to which service request packets are sent is updated each time a service request packet is received from a client 105. Thus, the load balancing according to the present invention is performed based on the real-time load status of the servers. As a result, appropriate load balancing can be performed even if there is a sudden surge in server accesses. Also, since the load balancing according to the present invention estimates the server load resulting from the service request packet, excessive communication load between servers and the load balancer and excessive server CPU load are prevented. Thus, the load balancing according to the present invention provides dynamic load balancing while maintaining high overall performance for the server system.

The following is a detailed description of an embodiment of the server load estimation processing module 101 and the server selection processing module 102 in the load balancer 100.

First, the server load estimation processing module 101 will be described.

In this embodiment, the service contents of service request packets are obtained through an HTTP (Hyper Text Transfer Protocol) header. An HTTP header is a header used in HTTP, which is the primary protocol used in WWW systems. The type of requested service, the type of data involved, and the like can be determined by comparing the header with a table prepared ahead of time. FIG. 2 shows an example of an HTTP header in a service request packet. In the example in FIG. 2, data at the location indicated by “http://www.sdl.hitachi.co.jp/index.html” is requested via the GET method. The processing load on a WWW server receiving the service request from a client is dependent on the type and size of the requested content data and the method. Thus, the server load estimation processing module 101 of this embodiment uses a method 201, which indicates the type of service requested by the client, and a URL 202, which indicates the data requested.

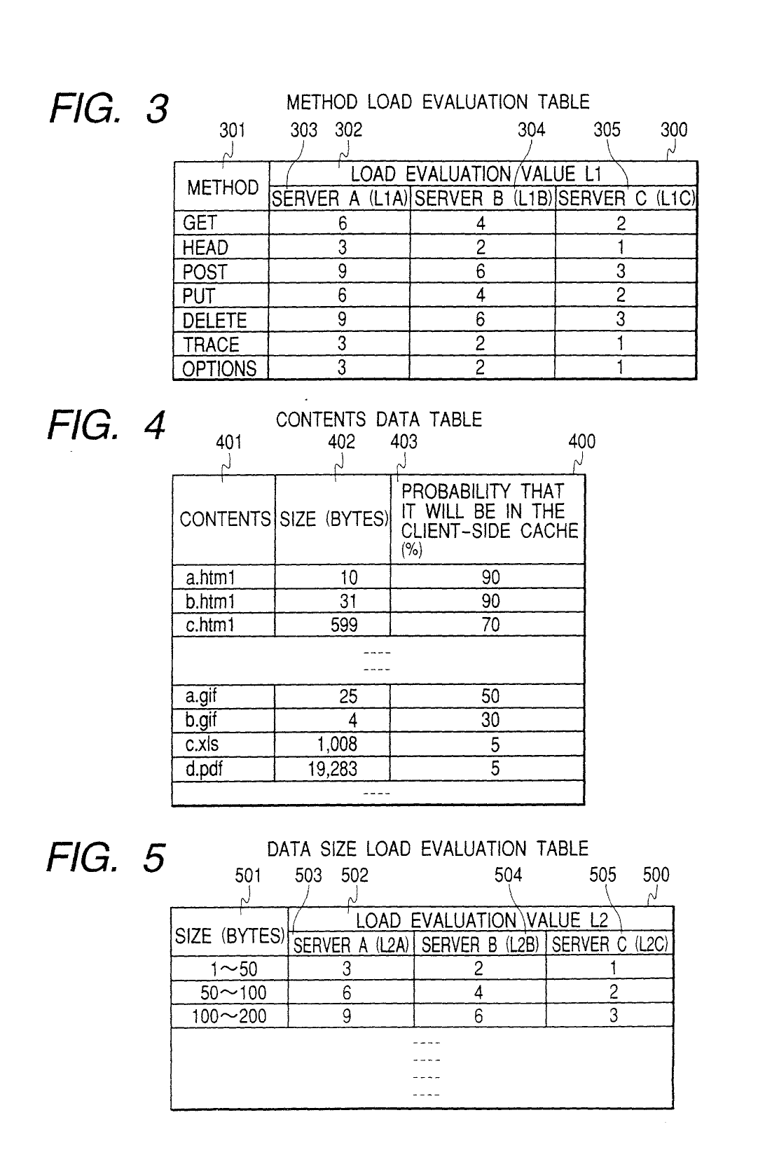

Load estimation values are calculated by looking up the load estimation table 103. The load estimation table 103 in this embodiment is formed from the five table types shown below. FIG. 3 through FIG. 7 show the data structures used in these tables.

1) A method load evaluation table 300

2) A content data table 400

3) A data size load evaluation table 500

4) A dynamic content generation program load evaluation table 600

5) A weight table 700

The method load evaluation table 300 shown in FIG. 3 is formed from a method field 301 and a load evaluation value field 302. The entries of the method field 301 contain all the methods that the servers can provide. The load evaluation value field 302 contains load evaluation values L1, which indicate the load resulting on a server when it executes the operations associated with a method. The field 302 includes fields for each of the servers. In this embodiment, a load evaluation value field 303 stores the load evaluation values L1A associated with the server A 107, a load evaluation value field 304 stores the load evaluation values L1B associated with the server B 108, and a load evaluation value field 305 stores the load evaluation values L1C associated with the server C 109. This table 300 can be looked up to obtain evaluation values (L1A, L1B, L1C) indicating the load on a server resulting from a method specified by a client.

The content data table 400 shown in FIG. 4 is formed from a contents field 401, a size field 402, and a field 403 indicating the probability that the contents are in the client-side cache. The entries of the contents field 401 contain all the content data in the servers. The size field 402 stores the sizes of the content data indicated by the contents field 401. The client-side cache probability field 403 contains the probability that the content data indicated in the contents field 401 will not be sent from the server to the client because the content data is cached by the client 105 or a proxy server in the Internet 106. This table 400 can be looked up to obtain the size of the data requested by a client 105 and the probability that the requested data will actually be sent from the server.

The data size load evaluation table 500 shown in FIG. 5 is formed from a size field 501 and a load evaluation value field 502. The sizes of content data provided by the servers are divided into stages, and the size field 501 indicates size ranges of the stages. The load evaluation value field 502 stores load evaluation values L2 representing the processing loads on each server resulting from requests for different data sizes. The field 502 contains fields for each of the servers. This embodiment includes a load evaluation value field 503 storing a load evaluation value L2A associated with the server A 107, a load evaluation value field 504 storing a load evaluation value L2B associated with the server B 109, and a load evaluation value field 505 storing a load evaluation value L2C associated with the server C 109. This table 500 can be looked up to obtain the load evaluation values (L2A, L2B, L2C) indicating the load to the servers resulting from requests for content data of different sizes.

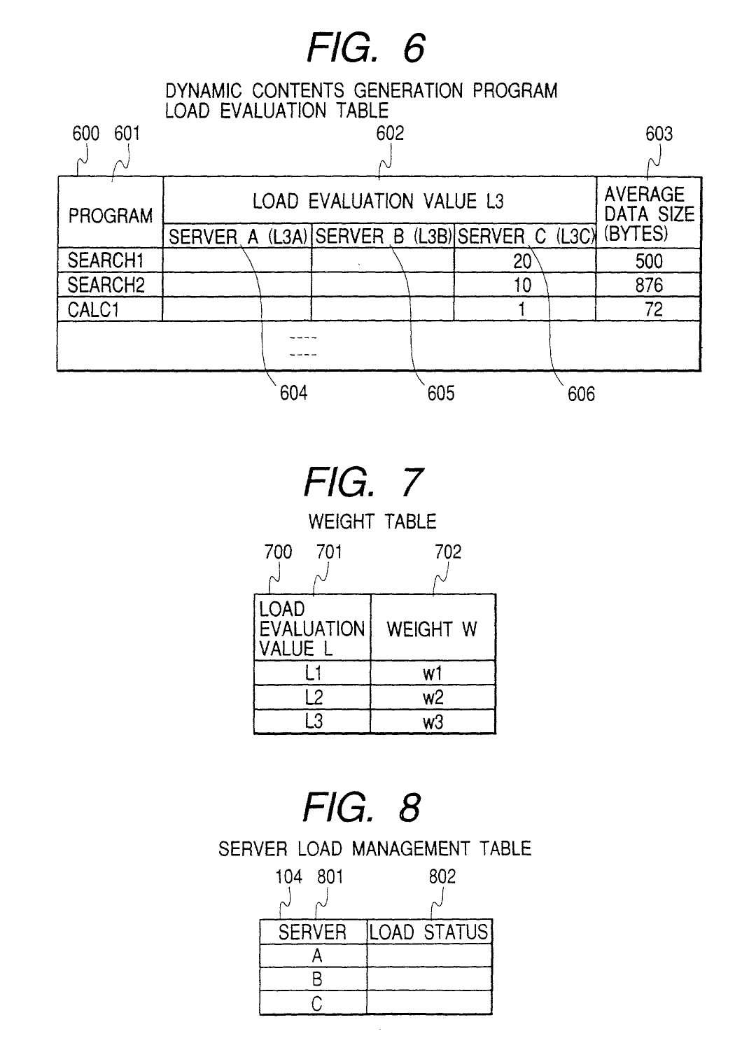

The dynamic content generation program load evaluation table 600 shown in FIG. 6 is formed from a program field 601, a load evaluation value field 602, and an average response data size field 603. The program field 601 contains the names of all the programs executed by the server to generate dynamic content data. The dynamic content generation programs in this embodiment are assumed to have the same processing load regardless of the input parameters. If the processing load varies depending on the input parameters, a parameters field can be set up in addition to the program field 601. The load evaluation value field 602 stores load evaluation values L3 indicating the load resulting from the execution of a dynamic content generation program. The field 602 includes a field for each server. A load evaluation value field 604 stores a load evaluation value L3A associated with the server A 107, a load evaluation value field 605 stores a load evaluation value L3B associated with the server B 108, and a load evaluation value field 606 stores a load evaluation value L3C associated with the server C 109. The average response data size field 603 stores average sizes of content data generated as a result of execution of a dynamic content generation program. In this embodiment, it is assumed that the size of the content data generated by a dynamic content generation program is the same regardless of the parameters. If there are significant size differences in generated content data depending on the parameters, a parameter field can be set up in addition to the program field. The table 600 is looked up to obtain load evaluation values (L3A, L3B, L3C) representing processing loads of programs executed by servers to generate content requested by the clients 105 as well as the average sizes of the content data generated as a result of execution of these programs.

The weight table 700 shown in FIG. 7 is formed from a load evaluation field 701 and a weight field 702. The load evaluation value field 701 stores the load evaluation value L1 through the load evaluation value L3 determined by looking up the method load evaluation table 300, the data size load evaluation table 500, and the dynamic content generation program load evaluation table 600. The weight field 702 stores weights for these load evaluation values. These weights are used when determining a load evaluation value for a service request packet using the load evaluation value L1 through the load evaluation value L3. The table 700 is looked up to obtain weights for load evaluation values for when the load evaluation value is calculated.

This concludes the description of the data structures in the load estimation table 103 shown in FIG. 3 through FIG. 7. The values for the entries in the tables in FIG. 3 through FIG. 6 are generated by performing tests before the system is started. If the content data or services provided by the servers are changed, tests are performed to update the tables using a spare system or when the system is not running (when the system is not connected to the Internet). The details of this operation will be described later. The weight table 700 in FIG. 7 is set up manually by a system administrator.

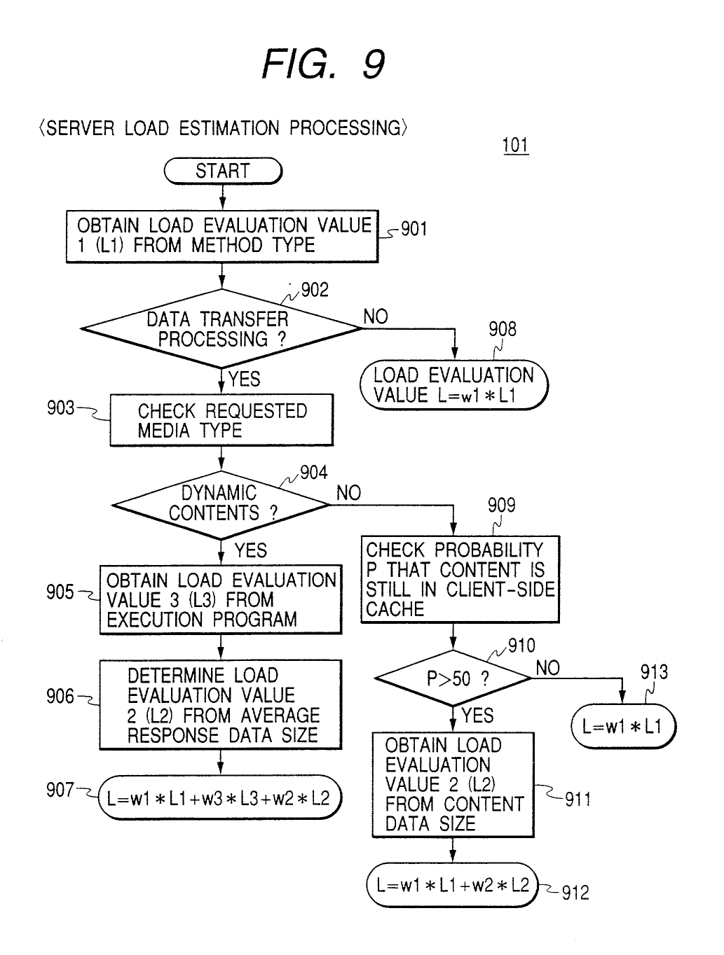

FIG. 9 shows the flow of operations involved in the server load estimation operation. The following is a description of the flow of operations involved in the server load estimation operation 101, with references to FIG. 9.

At step 901, the method load evaluation table 300 is looked up, and load evaluation values (L1A, L1B, L1C) associated with the method in the HTTP header are obtained for each of the servers using the field 303, the field 304, and the field 305. Step 902 determines whether the method type is a method such as GET or POST that involves content data being sent from the server. If the method does not involve the sending of content data, control proceeds to step 908, where the weight table 700 is looked up and a weight w1 for the load evaluation value L1 is obtained from the weight field 702. Then, an estimated load evaluation value Lx=w1*L1x (x=A, B, C) is calculated for each server. If the method involves the sending of content data, control proceeds to step 903, where the media type of the requested data is determined from the URL in the HTTP header. Step 904 determines whether the requested media is dynamic content. If the requested media is dynamic content, control proceeds to step 905. At step 905, the dynamic content generation program load evaluation table 600 is looked up. The load evaluation value L3 for each of the servers (L3A, L3B, L3C) resulting from execution of the dynamic content generation program is obtained using the field 604, the field 605, and the field 606. Also, the average size of the response data is obtained using the field 603. At step 906, the data size load evaluation table 500 is looked up using the average response data size obtained at step 905, and the load evaluation value L2 for each server (L2A, L2B, L2C) is obtained using the field 503, the field 504, and the field 505. At step 907, the weight table 700 is looked up, and the weight (w1, w2, w3) for each of the load evaluation values (L1, L2, L3) is obtained. The load evaluation value for each server is determined using Lx=w1*L1x+w2*xL2x+w3*L3x (x=A,B,C). If the requested media is static data, control proceeds to step 909. At step 909, the content data table 400 is looked up, and a probability P that the data will exist in client-side cache is determined using the field 503. Step 910 determines whether or not the probability P is greater than 50% or not.

If the probability P is greater than 50%, it is determined that content data is to be sent from a server, and control proceeds to step 911. At step 911, the data size load evaluation table 500 is looked up. Using the content data size obtained from the size field 502, the load evaluation value L2 for each server (L2A, L2B, L2C) is obtained from the field 503, the field 504, and the field 505. At step 912, the weight table 700 is looked up and the weight (w1, w2) for each load evaluation value (L1, L2) is obtained and the load evaluation value Lx=w1*L1x+w2*L2x (x=A, B, C) is determined. If the probability P is less than 50%, the content data will not be sent from a server, and control proceeds to step 913. At step 913, the weight table 700 is looked up, the weight w1 for the load evaluation value L1 is obtained from the field 702, and the load evaluation value Lx=w1*L1x (x=A, B, C) is determined.

Step 910 determines whether the content data is to be sent from a server based on “whether or not the probability that the data is in the client-side cache is at least 50%”. However, this value can be changed as appropriate. Also, the probability cut-off can be varied according to the size of the content data.

The operations described above allow a load estimation value to be estimated.

After executing the server load estimation processing module 101, the load balancer 100 of the present invention executes the server selection processing module 102. Next, the server selection processing module 102 will be described.

The server selection processing module 102 looks up the server load management table 104, selects a server to which the service request is assigned, and converts the destination address in the service request packet to the server address.

FIG. 8 shows the data structure in the server load management table 104. The table 104 is formed from a server field 801 and a load status field 802. The entries of the server field 801 store the names of all the servers to which the load balancer 100 sends server request packets. In this embodiment, there is an entry for the server A 107, an entry for the server B 108, and an entry for the server C 109. The load status field 802 stores load status values in the form of totals of past load evaluation values for a server over a fixed period of time. In this embodiment, the load status field 802 stores the load evaluation value sums for the past 1 second.

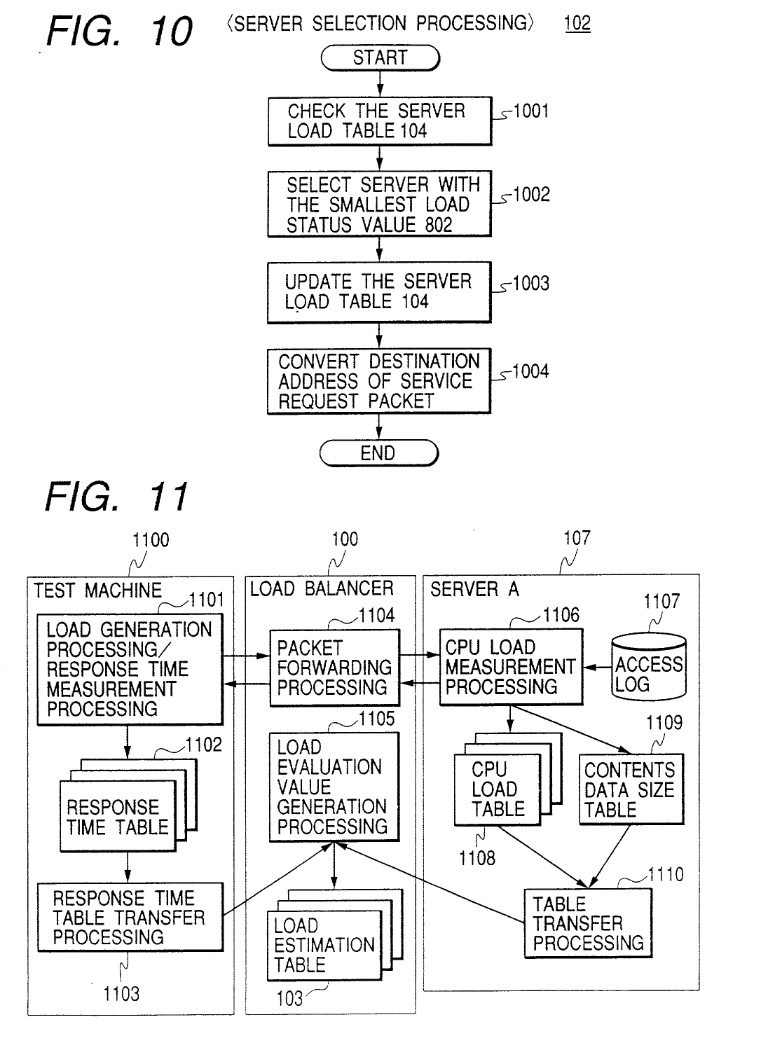

FIG. 10 shows the flow of operations of the server selection operation 102. The following is a description of the flow of operations in the server selection operation, with references to FIG. 10.

First, at step 1001, the server load management table 104 is looked up. At step 1002, the server with the lowest value in the load status field 802 is selected. At step 1003, the load status field 802 entry corresponding to the selected server is updated with the load evaluation value estimated in the server selection operation 102. The corresponding load status field 802 is updated with the load evaluation value LA if the server A 107 is selected, the load evaluation value LB if the server B 108 is selected, and the load evaluation value LC if the server C 109 is selected. At step 1004, the destination address in the packet header of the service request packet is converted to the address of the server selected at step 1002.

In this embodiment, the server load management table 104 is looked up and the server with the lowest evaluation value is selected. However, it would also be possible to select servers in a round-robin fashion, where if a the load evaluation value of the selected server is at or greater than a certain threshold value (i.e., the server is overloaded), the server is not selected and the next server in the round-robin is selected.

The above describes an embodiment of load sharing in the load balancer 100.

In this embodiment, the load balancer 100 distributes service request packets to the server A 107, the server B 108, and the server C 109. However, the number of servers to which service request packets are distributed is not restricted to three.

Also, this embodiment assumes that the servers have different processing powers. However, the present invention can be used even if the servers all have the same processing power. If the servers all have the same processing power, there is no need to have a separate field for each of the servers in the load evaluation value field 302 in the method load evaluation table 300, the load evaluation field 502 in the data size load evaluation table 500, and the load evaluation value field 602 in the dynamic content generation program load evaluation table 600. Also, for the load evaluation values L1, L2, L3, only one load evaluation value is needed. In the server load estimation operation 101, only one load evaluation value needs to be determined, and there is no need to determine a load evaluation value for each server.

Next, an embodiment for operations to generate and update the load estimation table 103 will be described. In these operations, the values for entries in the method load evaluation table 300, the content data table 400, the data size load evaluation table 500, and the dynamic content generation program load evaluation table 600 in the load estimation table 103 are generated or updated. In this embodiment, the weight table 700 is set up manually by a user.

FIG. 11 shows the architecture of the operation for generating/updating the server load management table 104. These operations are performed by a single test machine 1100, the load balancer 100, and a single server. The servers perform separate operations for when the server A 107 is connected, when the server B 108 is connected, and when the server C 109 is connected. However, if the servers all have the same processing power, the same operations can be performed. This operation is performed either when the WWW system shown in FIG. 1 is not operating (i.e., when there is no connection to the Internet) or by using a backup system formed with a load balancer having the same performance and functions as the load balancer 100 and a server having the same performance, functions, and content data as the servers in the main system.

Since the same operations are performed when the server A 107 is connected, when the server B 108 is connected, and when the server C is connected, so the description below will cover cases where the server A 107 is connected.

In this operation, a load generation processing/response time measurement processing module 1101 of a test machine 1100 first sends a service request packet to the server A 107, and simultaneously begins measuring the response time for the server A 107 to reply with a service response packet. The load balancer 100 receives the service request packet and sends the service request packet to the server A 107 by way of a packet forward processing module 1104. After receiving the service request packet, the server A 107 executes the operation associated with the requested service and, at the same time, measures the CPU load using a CPU load measurement processing module 1106. The CPU load measurement result is stored in a CPU load table 1108. After the operation for the service request is completed, a service response packet containing the processing results is sent. The service response packet goes through the packet forward processing module 1104 of the load balancer 100 and is sent to the test machine 1100. After the service response packet is received, the test machine 1100 records the measured response time in a response time table 1102. This measurement operation is performed for all the services and all the content data that the servers can provide.

After the measurement operations described above are completed, the test machine 1100 uses a response time table transfer processing module 1103 to send the response time table 1102 to the load balancer 100. The server A 107 uses a table transfer processing module 1110 to send the CPU load table 1108 and a content data size table 1109, which contains size information for each set of content data, to the load balancer 100.

The load balancer 100 receives the response time table 1102, the CPU load table 1108, and the content data size table 1109. Based on this information, the load balancer 100 uses a load evaluation value generation processing module 1105 to generate load evaluation values and to generate or update the load estimation table 103.

The following operations will be described in detail.

1) the load generation processing/response time measurement operation 1101 in the test machine 1100

2) the CPU load measurement operation 1106 in the server A 107

3) the load evaluation value generation operation 1105 in the load balancer 100

First, the load generation processing/response time measurement operation 1101 in the test machine 1100 will be described.

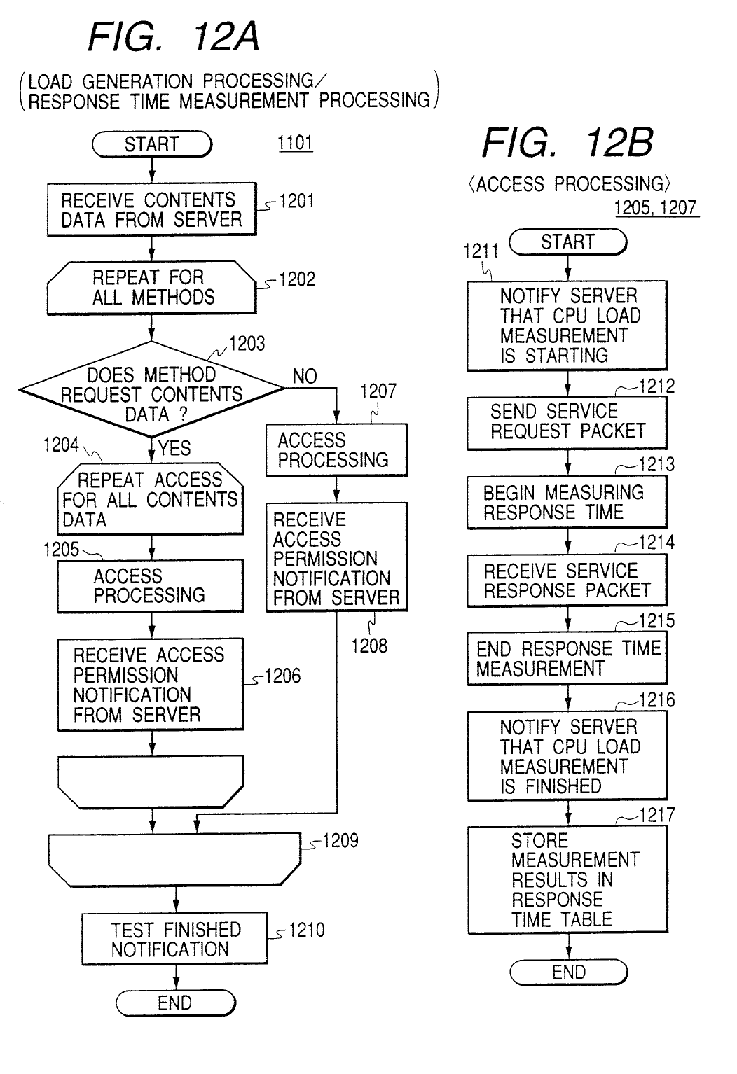

FIG. 12A shows the flow of operations performed in the test machine 1100. At step 1201, information about all the methods and all content data that can be provided by the server A 107 is received from the server A 107. Based on this information, at step 1202 through step 1209, access operations are repeated (step 1205 or step 1207) for all the services and content data provided by the server. The detailed flow of operations in the access operations (step 1205 or step 1207) is shown in step 1211 through step 1217 in FIG. 12B. At step 1211 of the access operation, the server is first notified that CPU load measurement is beginning. At step 121, a service request packet is sent to the server. Right after this packet is sent, response time measurement is begun at step 1213. At step 1214, a service response packet is received from the server A 107 and, at the same time, the response time measurement is stopped at step 1215. At step 1216, the server A 107 is notified that CPU load measurement is completed. At step 1217, the response time measurement result is recorded in the response time table 1102, and the operation is exited.

After the access operation at step 1205 or step 1207 is completed, the test machine 1100 waits for an access permission notification to be received from the server at step 1206 or step 1208. When an access permission notification is received from the server, control returns to step 1202 and the access operation is repeated.

When all the services and content data have been accessed, control proceeds to step 1210, and the server A 107 is notified that testing is finished.

The response time table 1102 is formed from one or more tables. In this embodiment, the table is formed from a method table 1400, a content data table 1500, and a dynamic content generation program table 1600.

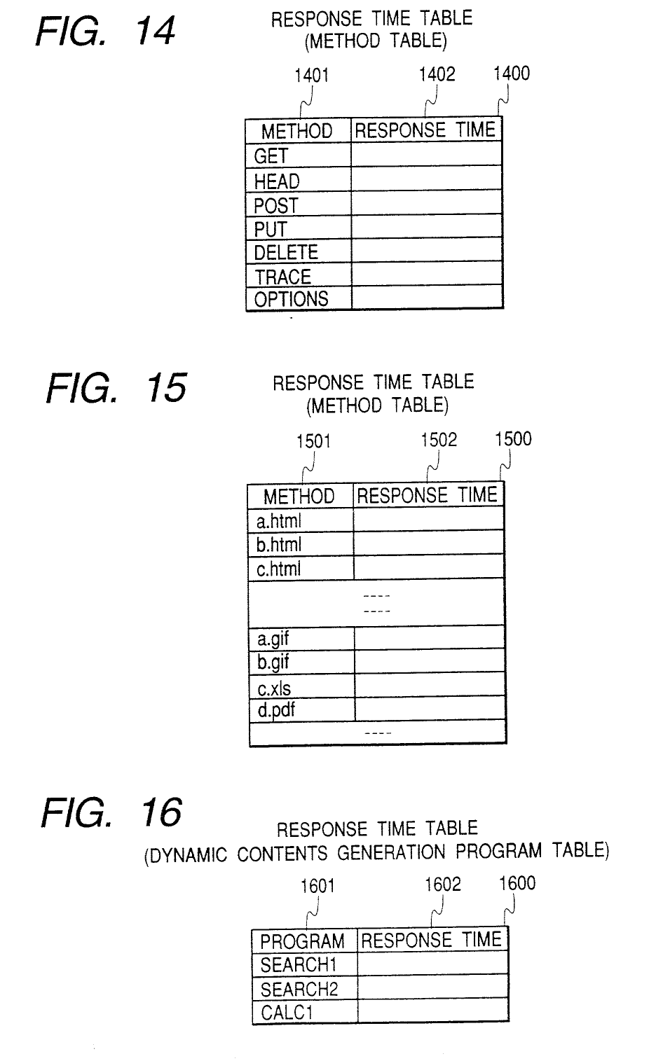

The method table 1400 shown in FIG. 14 includes a method field 1401 and a response time field 1402. The entries of the method field 1401 stores all the methods that the server A 107 can provide. The entries of the response time field 1402 store the average response times of the server A 107 measured for each method when the server A 107 was accessed by the test machine 1100. The average access response time for each method can be determined either by taking the average value for all access patterns provided by the server A 107 or by taking the average value for representative access patterns. The information in the table 1400 is used to generate or update the method load evaluation table 300.

The content data table 1500 shown in FIG. 15 is formed from a content field 1501 and a response time field 1502. The entries of the content field 1501 store the names of all content data (static data) provided by the server A 107. The response time field 1502 stores the response times for when content data is requested by the test machine 1100 using the GET method. The information in the table 1500 is used to generate or update the data size load evaluation table 500.

The dynamic content generation program table 1600 shown in FIG. 16 is formed from a program field 1601 and a response time field 1602. The entries of the program field contain the names of all dynamic content generation programs in the server A 107. The response time field 1602 stores the response times for when dynamic content generation programs are executed in response to a request from the test machine 1100 with the GET method. The information in the table 1600 is used to generate or update the dynamic content generation program load evaluation table 600.

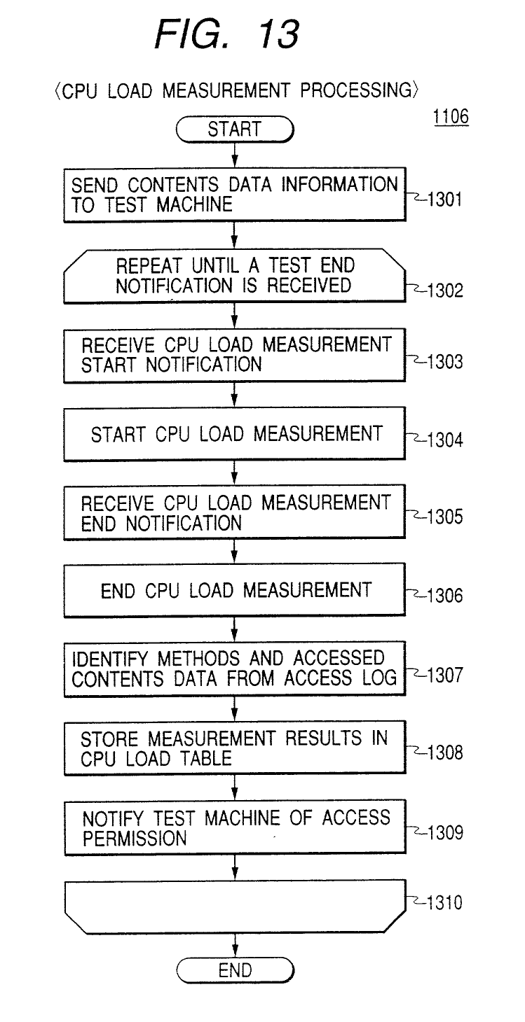

Next, the CPU load measurement operation 1106 in the server A 107 will be described. FIG. 13 shows the flow of operations. First, at step 1301, information about all the methods and all the content data that can be provided by the server A 107 is sent to the test machine 1100. Next, control proceeds to step 1302, where the operations from step 1302 through step 1310 are repeated until a notification is received from the test machine 1100 to indicate that testing has been completed. Step 1303 waits until a notification is received from the test machine 1100 to indicate the start of CPU load measurement. Once this notification is received, CPU load measurement is begun at step 1304. At step 1305, a notification is received from the test machine 1100 to stop CPU load measurement, and CPU load measurement is stopped at step 1306. At step 1307, an access log 1107 of the server is looked up to identify the method, the execution program, and the content data associated with the access from the test machine 1100. At step 1308, the CPU load obtained from step 1306 and the information obtained from step 1307 are used to record the corresponding entry in the CPU load table 1108. At step 1309, an access permission notification is sent to the test machine 1100. Control goes back to step 1303, which waits for a notification from the test machine 1100 to start CPU load measurement.

The operation is exited when a test completion notification is received from the test machine 1100.

The CPU load table 1108 is formed from one or more tables. As with the response time table 1102, the CPU load table 1108 in this embodiment is formed from a method table 1700 and a dynamic content generation program table 1800.

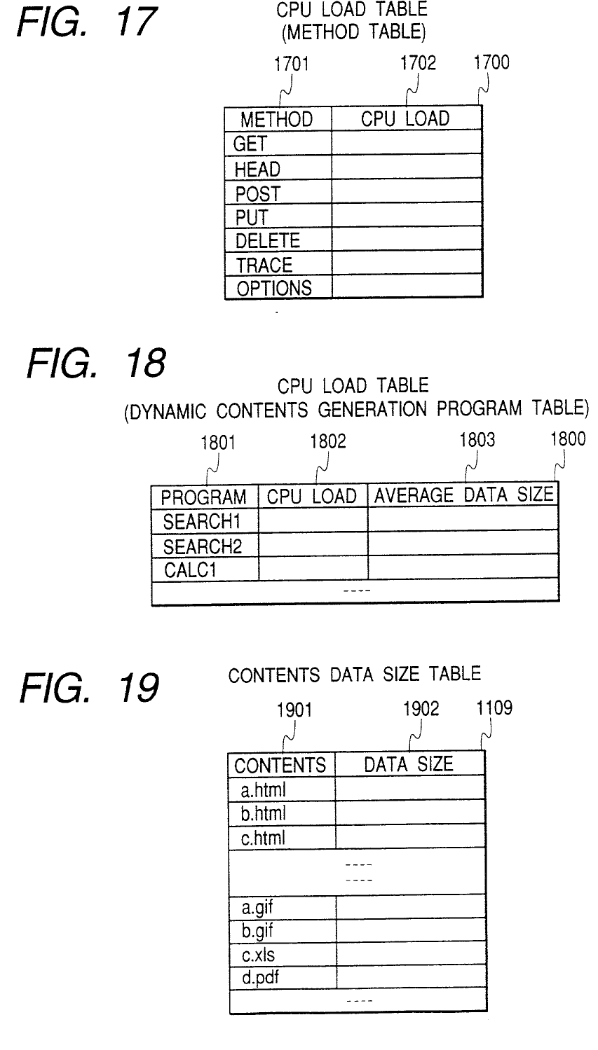

The method table 1700 shown in FIG. 17 is formed from a method field 1701 and a CPU load field 1702. The entries of the method field 1701 store the names of all the methods that can be provided by the server A 107. The entries of the CPU load field 1702 store the average CPU loads measured when the methods are requested and operations are executed. These average CPU loads can be either averages taken for all access patterns provided by the server or can be averages of representative access patterns. The information in the table 1700 is used to generate or update the method load evaluation table 300.

The dynamic content generation program table 1800 shown in FIG. 18 is formed from a program field 1801, a CPU load field 1802, and an average response data size 1803. The entries of the CPU load field 1802 store the CPU load on the server A 107 resulting from execution of operations performed in response to requests accompanied by execution of dynamic content generation programs. The average data size field 1803 stores the average data size of the response data sent to the client as a result of execution of the dynamic content generation programs.

When the server A 107 looks up the access log 1107 at step 1307 or when the CPU load measurement operation 1106 is completed, the server A 107 analyzes the access log 1107 and generates the content data size table 1109 shown in FIG. 19. The content data size table 1109 is formed from a content field 1901 and a data size field 1902. The entries of the content field 1901 store the content data (static content data) provided by the server A 107. The data size field 1902 store the sizes of the content data.

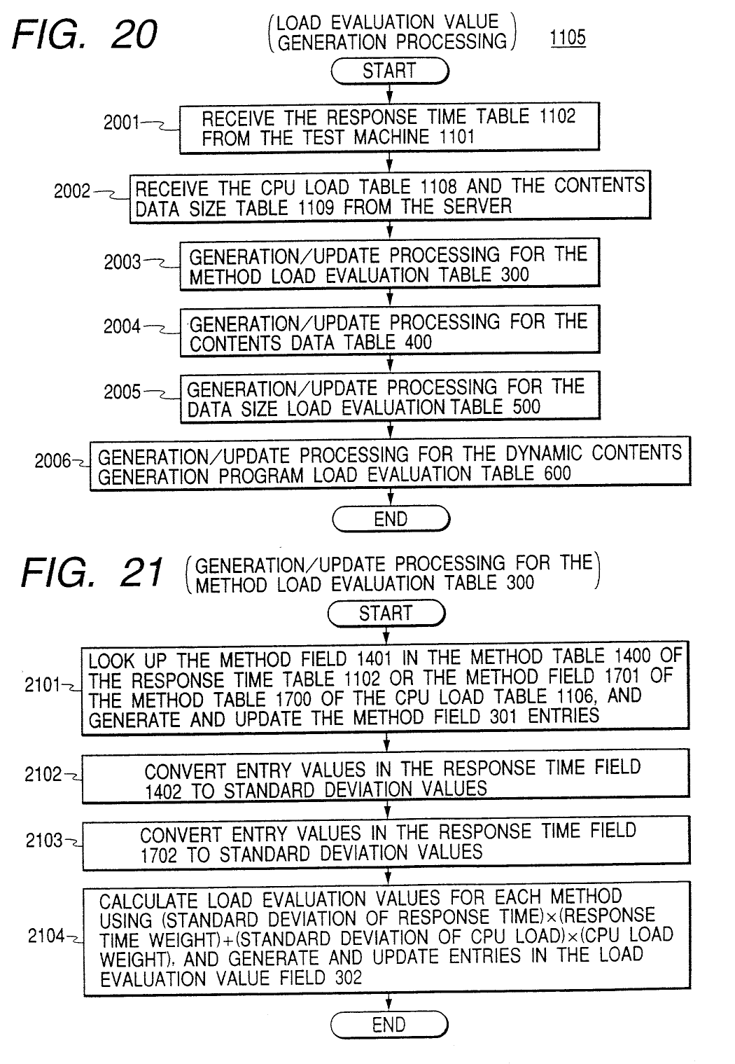

Finally, the load evaluation value generation operation 1105 of the load balancer 100 will be described. First, using the flowchart shown in FIG. 20, the main flow of operations in the load evaluation value generation operation 1105 will be described.

At step 2001, the load balancer receives from the test machine 1100 information from the response time table 1102 (the method table 1400, the content data table 1500, and the dynamic content generation program table 1600). At step 2002, information from the CPU load table 1108 (the method table 1700 and the dynamic content generation program table 1800) and the content data size table 1109 is received. At step 2003, the information received at step 2001 and step 2002 is used to generate and update the entries in the method load evaluation table. At step 2400, the content data table 400 is generated and updated. At step 2005, the data size load evaluation table 500 is generated and updated. At step 2006, the dynamic content generation program load evaluation table 600 is generated and updated, and the operation is exited.

The following is a detailed description of the operations performed at step 2003 through step 2006.

FIG. 21 shows the flow of operations performed to generate and update the method load evaluation table 300 at step 2003. The method load evaluation table 300 is generated and updated using the method table 1400 of the response time table 1102 and the method table 1700 of the CPU load table 1108. First, at step 2102, the method field 1401 of the response time table 1102 (the method table 1400) or the method field 1701 of the CPU load table 1108 (the method table 1700) is looked up and new entries are generated for and unneeded entries are deleted from the method field 301. At step 2102, each of the entries in the response time field 1402 is converted to a standard deviation value. At step 2103, each of the entries in the CPU load field 1702 is converted to a standard deviation value. At step 2104, the load evaluation value for each method is calculated as (standard deviation of response time)*(weight of response time)+(standard deviation of CPU load)*(weight of CPU load), and the calculated value is entered in the load evaluation field 302. Since the load evaluation values for the server A 107 are determined here, entries of the field 303 are generated or updated.

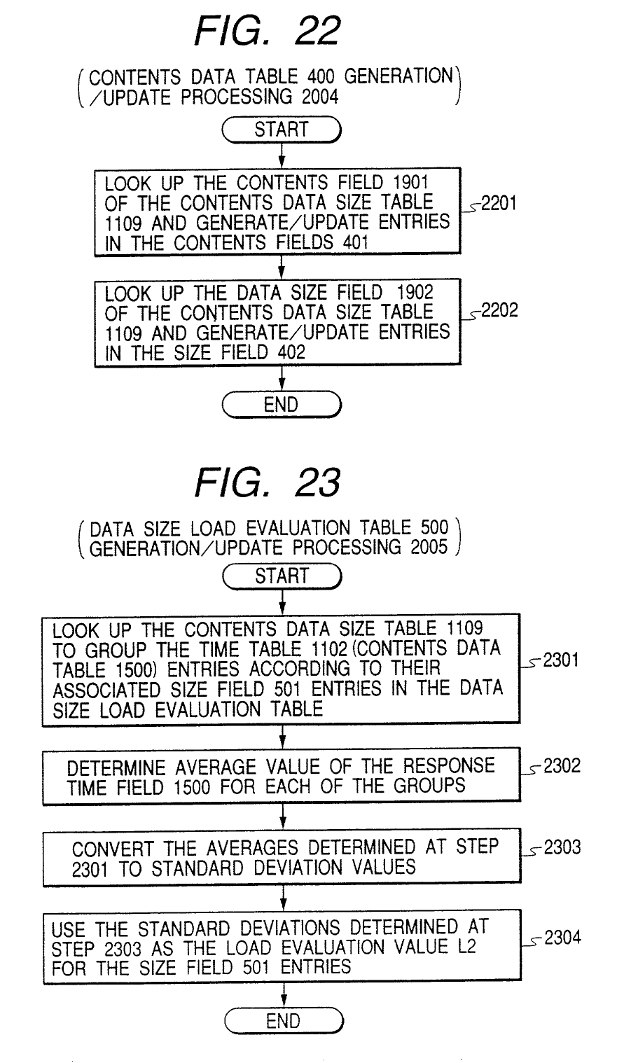

Next, the flow of operations in the content data table 400 generation and updating operation 2004 will be described using FIG. 22. At step 2201, the content field 1901 of the content data size table 1109 is looked up, and entries of the content field 401 are generated or updated. At step 2202, the data size field 1902 of the content data size table 1109 is looked up and the entries of the size field 402 are generated or updated. With these operations, the content data table 400 is generated or updated.

Next, the flow of operations in the data size load evaluation table 500 generation/updating operation 2005 will be described using FIG. 23. First, at step 2301, the content data size table 1109 is looked up to identify which entries in the data size load evaluation table 500 correspond to the entries in the content data table 1500. The entries of the content data table 1500 are grouped based on entries in the data size load evaluation table 500. At step 2302, the average of the response time field 1500 for each formed group is determined. At step 2303, the averages determined at step 2302 are converted to standard deviation values. At step 2304, the load evaluation values L2 associated with the size field 501 are stored in the associated fields in the load evaluation field 502 (the field 503 for the server A 107) in the form of the standard deviation values determined at step 2303.

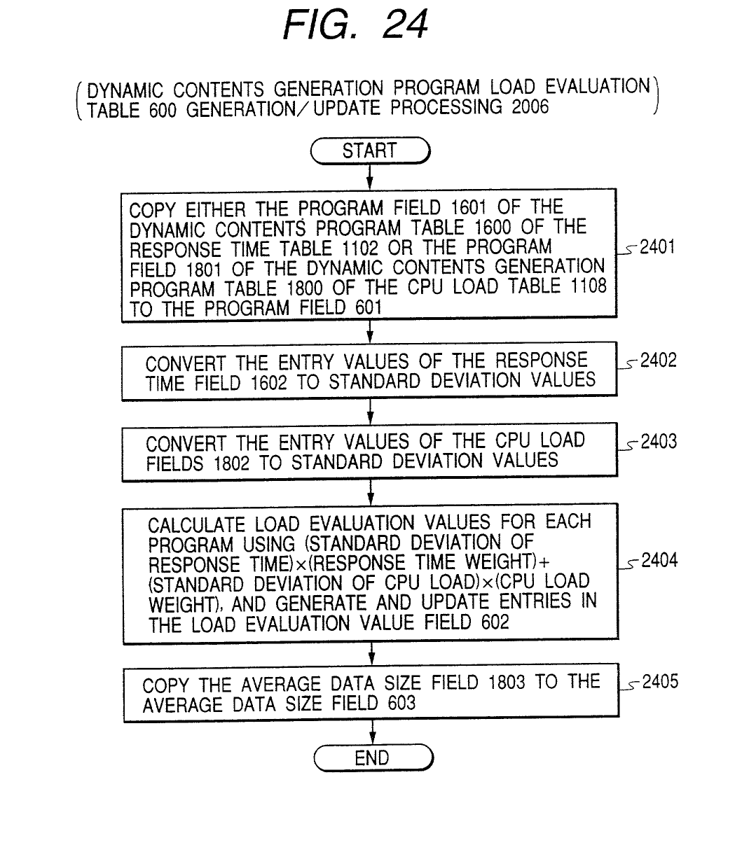

Finally, the flow of operations in the dynamic content generation program load evaluation table 600 generation and updating operation 2006 will be described using FIG. 24. First, at step 2401, the program field 1601 of the dynamic content generation program table 1600 in the response time table 1102 or the program field 1801 of the dynamic content generation program table 1800 is copied to the program field 601. At step 2402, the entries in the response time field 1602 of the dynamic content generation program table 1600 in the response time table 1102 are converted to standard deviation values. At step 2403, the entries of the CPU load field 1802 of the dynamic content generation program table 1800 of the CPU load table 1108 are converted to standard deviation values. At step 2404, the load evaluation values of the programs are calculated as (standard deviation value of response time)*(weight of response time)+(standard deviation value of CPU load)*(weight of CPU load) and are stored in the appropriate field of the load evaluation field 602 (the field 604 for the server A 107). At step 2405, the average data size field 1803 of the dynamic content generation program table 1800 in the CPU load table 1108 is copied to the average response data size field 603.

With the operation above, the entries in the load estimation table 103 that indicate the load evaluation values for the server A 107 are generated or updated. The load evaluation values for the server B 108 and the server C 109 can be determined using operations similar to the one described above.

The field 403 indicating the probability that the content data in the content data table 400 is in the client-side cache is not generated in the response time table transfer operation 1103. Entries in the field 403 are generated or updated by analyzing the access log in the server A 107 while the system shown in FIG. 1 is actually operating. This operation can be provided by analyzing the access log at the server A 107 just once after the system is started and before content data is updated and notifying the load balancer 100 of the cache-hit rate for the content data.

A program implementing the load balancing and the load estimation method according to the present invention as described above can be stored on a computer-readable storage medium so that this program can be read into main memory and executed.

With the load balancer according to the present invention, a service request from a client can be dynamically assigned to one of many servers based on real-time server load information. Thus, load balancing appropriate for the loads placed on the servers can be provided even if there is a sudden spike in accesses. Also, the load balancing according to the present invention can maintain high server system performance since it does not require unnecessary communication between the load balancer and the servers and does not require internal load monitoring operations within the servers.

What is claimed is:

1. A load balancer connected to a network connecting a plurality of clients requesting services and a plurality of servers executing operations based on said requests from said clients and replying with processing results comprising:
means for examining header information in request data from said client;
means for estimating, based on said header information and contents of said request data, processing load resulting from execution by said servers;
means for storing totals of said load estimates over a fixed past period for each of said servers;
means for dynamically selecting a server to which said request data is to be sent based on estimates of processing load on said servers resulting from current request data and total load for said servers; and
means for forwarding said request data to said servers.

2. A load balancer as described in claim 1 further comprising:
means for identifying a requested service type from said header of said request data; and
means for estimating processing load on said servers based on said service type.

3. A load balancer as described in claim 1 further comprising:
means for calculating requested data size based on said request data header and information about content data in said servers; and
means for estimating processing load on said servers based on said request data size.

4. A load balancer as described in claim 1 further comprising:
means for identifying program types to be executed by said servers based on said request data header; and
means for estimating processing load on said servers based on execution of said programs.

5. A server load estimation method using an information processing device connected to a server and a client sending a service request packet to said server comprising the following steps:
requesting access to all services and all content data that can be provided by said server;
measuring processing load on said server associated with said request; and
generating data used to estimate, using said measurement results, server load resulting from request data from said client based on a header of said request data.

6. A load estimation method as described in claim 5 wherein, in said step for measuring processing load on said server, server processing load is estimated by measuring response time between when said client sends said service request packet and when a service response packet is received.

7. A load estimation method as described in claim 5 wherein, in said step for measuring processing load on said server, server processing load is estimated by measuring CPU load when said server receives said service request packet and executes an operation based on said request.

8. A computer-readable storage medium storing a program for implementing a method for estimating server load using an information processing device connected to a server and a client for sending a service request packet to said server, said method including the following steps:
requesting access to all services and all content data that can be provided by said server;
measuring processing load on said server associated with said request; and
generating data used to estimate, using said measurement results, server load resulting from request data from said client based on a header of said request data.

9. A load balancing method using a processing device connected to a network connecting a plurality of clients requesting services and a plurality of servers executing operations based on said requests from said clients and replying with results from said operations, said method comprising the following steps:
examining header information in request data from said clients;
estimating, based on said header information and contents of said request data, processing load resulting from execution by said servers;
storing totals of said load estimates over a fixed past period for each of said servers;
selecting dynamically a server to which said request data is to be sent based on estimates of processing load on said servers resulting from current request data and total load for said servers; and
forwarding said request data to said servers.

10. A computer-readable storage medium storing a program for implementing a method for estimating server load using an information processing device connected to a plurality of clients requesting services and a plurality of servers executing operations based on requests from said clients and replying with results from said operations, said method including the following steps:
examining header information in request data from said clients;
estimating, based on said header information and contents of said request data, processing load resulting from execution by said servers;
storing totals of said load estimates over a fixed past period for each of said servers;
selecting dynamically a server to which said request data is to be sent based on estimates of processing load on said servers resulting from current request data and total load for said servers; and
forwarding said request data to said servers.
